(19) United States
(12) Patent Application Publication
(10) Pub. No.: US 2006/0254101 A1
(43) Pub. Date: Nov. 16, 2006

(54) Picture framing apparatus for use in a motorized vehicle

(76) Inventors: Donald J. Callison, Sacramento, CA (US); James F. McCann, Sacramento, CA (US)

Correspondence Address: FISH & RICHARDSON, PC, P.O. BOX 1022, MINNEAPOLIS, MN, 55440-1022, US

(21) Appl. No.: 11/127,974

(22) Filed: May 11, 2005

(51) Int. Cl. G09F 21/04

(52) U.S. Cl. 40/593

(57) ABSTRACT

The present disclosure includes systems and techniques relating to the display of photographs in motorized vehicles. In general, in some implementations, an apparatus for displaying a picture on a sun visor in a motorized vehicle can include a connector configured and arranged to removably couple with the sun visor of the motorized vehicle, a frame configured and arranged to receive and hold the picture for display in the motorized vehicle, and an attachment member configured and arranged to removably couple with at least a portion of the frame to form a connecting interface between the attachment member and the frame, wherein the attachment member includes a decoration that obscures at least a portion of the picture when in the frame, and the attachment member is removable using a single hand and without tools.

### BACKGROUND

The present application describes systems and techniques relating to the display of photographs in motorized vehicles.

Various approaches to displaying photographs in cars have been used previously. These approaches have included new frame connectors used to attach traditional frames to the interior components of a car's passenger compartment, such as the sun visor and ventilation grills. These approaches have also included new frame designs used to facilitate the display of multiple photographs or other items (e.g., cards and tickets) having different dimensions.

### SUMMARY

The present disclosure includes systems and techniques relating to the display of photographs in motorized vehicles. In general, in some implementations, an apparatus for displaying a picture on a sun visor in a motorized vehicle can include a connector configured and arranged to removably couple with the sun visor of the motorized vehicle, a frame configured and arranged to receive and hold the picture for display in the motorized vehicle, and an attachment member configured and arranged to removably couple with at least a portion of the frame to form a connecting interface between the attachment member and the frame, wherein the attachment member includes a decoration that obscures at least a portion of the picture when in the frame, and the attachment member is removable using a single hand and without tools.

The connector and attachment member can be implemented in various manners. For example, the connector can include a hook-based fastener. The attachment member can include a material having a physical property that causes the attachment member to releasably adhere to the frame. The attachment member can include a magnet. The attachment member can include a top portion and side portions, the side portions having dimensions that fit snuggly around the at least a portion of the frame to form the connecting interface. Moreover, the sun visor can include a mirror, the frame can be configured to fit on the sun visor without blocking the mirror, and the decoration need not be limited to lateral dimensions of the frame.

The invention can be implemented to realize one or more of the following advantages. A formal, organized picture framing apparatus can provide a prominent location to display pictures (e.g., photographs) in a motorized vehicle, such as on a sun visor in the interior of a car. The frame can facilitate picture display in a manner that reflects an individual's own tastes and interests. The frame can also facilitate quick changes to the picture being displayed, and to an overall appearance of the picture on display, while also serving to hold the picture on display in a secure manner within the motorized vehicle while the vehicle is in use. The frame can also be designed to hold additional items, such as vehicle registration slips/cards, insurance information or emergency identification cards.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 shows a sun visor with a picture frame attached.

FIGS. 2-4 show perspective views of example picture frames.

FIG. 5 shows example frame covers including different decorations.

Like reference symbols in the various drawings indicate like elements.

### DETAILED DESCRIPTION

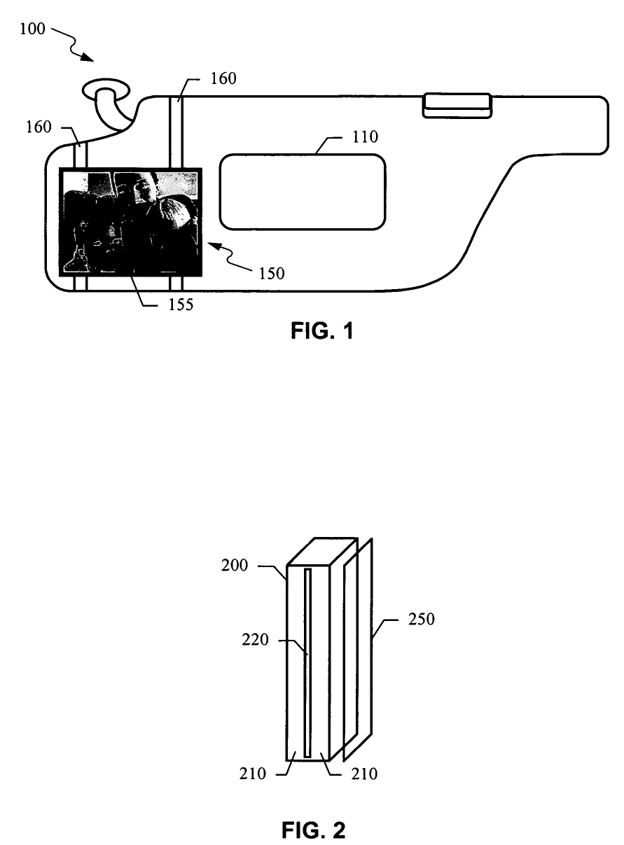

FIG. 1 shows a sun visor 100 with a picture frame 150 attached. The sun visor 100 is a component of a motorized vehicle, such as a car, truck, motor home, bus, airplane, train, boat, etc. The sun visor 100 can include a mirror 110, and the picture frame 150 can be of a size configured to fit on the visor 100 without blocking the mirror 110 (e.g., three inches high by five inches wide, five inches high by three inches wide, or other dimensions).

The frame 150 is attached to the visor 100 using a connector 160. The connector 160 can be a hook-based fastener, such as the strip tape shown in FIG. 1 (e.g., hook-and-loop-based fastening tape or hook-and-hook-based fastening tape, such as VELCRO tape, which can be attached to the frame by an adhesive or by inserting the fastening tape through slits or openings in the back of the frame that allow the tape to be rotationally oriented with respect to the frame before being secured to the visor). Various other types of connectors can also be used, such as mounting clips, magnets or elastic bands.

The frame 150 receives and holds a picture and can include various design elements that enhance the presentation of the picture. For example, the frame 150 can include a border 155 and/or other decoration that obscures at least a portion of the picture. The border 155 provides additional visual framing of the picture and can be made of different materials and can have different colors. The border 155 can be made of material with different tactile properties from the rest of the frame 150 (e.g., cloth, leather, fur, metal, plastic with a rough surface), the border 155 can be made of a colored, transparent material (i.e., a partially opaque material that obscures the picture by coloring its visual appearance), and the border 155 can be made of a combination of such materials and can include other design elements (e.g., words or phrases, as described further below).

The design elements of the frame 150 can be split between a frame body and a frame cover, allowing an individual to readily customize the frame's appearance as desired. For example, the frame body can be a clear plastic, rounded-corners rectangle (it is to be understood that the shape of the frame 150 can also be a design element of the frame, and the present invention is not limited to specifically rectangular frames, either with or without rounded-corners), and the frame cover can include the border 155. The frame cover can be mounted over the frame body in a quick-release fashion, such as described below.

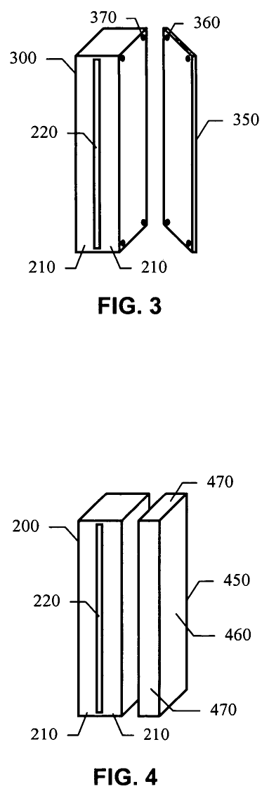

FIG. 2 shows an example picture frame. The example picture frame includes a frame body 200 and a frame cover 250. The frame body 200 can be two transparent plastic panels 210 coupled together at three of four sides, thereby forming a slot 220 into which a picture can be inserted. The frame body 200 can be constructed of a durable, lightweight, plastic material, such as a polyvinyl chloride (PVC) material. The frame body 200 should have a total thickness suitable to the expected display location, such as a total thickness of less than half an inch in the case of visor attachment, and the slot 220 should be large enough to receive typical photographic paper. For example, the slot 220 can be designed to receive and hold up to three photos. The frame body 200 can be flexible or rigid. The frame body 200 can securely hold one or more pictures (e.g., the opening to the slot 220 can be on the side of the frame body 200 in the case of visor attachment), and the frame body 200 can serve as a frame itself, even without a frame cover 250 attached.

The frame cover 250 mounts over the frame body 200 in a quick-release fashion and obscures at least a portion of the picture in the frame body 200. In this example, the frame cover 250 includes a material having a physical property that causes the frame cover 250 to releasably adhere to the frame body 200. For example, the frame cover 250 can be made of a thin, flexible, plastic material having a smooth surface that links the frame cover 250 with the frame body 200 when the frame cover 250 is placed on the frame body 200 (e.g., through electrostatic attraction, shear air pressure, or other forces caused by the physical shape of the frame cover's surface in relation to the frame body). Alternatively, a material can be applied to one side of the frame cover 250 to generate an adhesive force, such as a thin layer of oil or glue. In general, the physical property of the material used to attach the frame cover 250 to the frame body 200 in this example relates to surface adhesion forces created between the two surfaces. Other approaches to forming a quick-release coupling for attaching the frame cover to the frame body are also possible, including some that allow the frame cover to have significant weight and still attach securely.

FIG. 3 shows another example picture frame. In this example, a frame cover 350 includes one or more magnets 360 that have their magnetic poles arranged with respect to one or more magnets 370 on the frame body 300 so as to cause the frame body 300 to attract and support the frame cover 350. The number, size, shape and locations of the magnets 360, 370 can also be a design element of the frame.

FIG. 4 shows another example picture frame. In this example, a frame cover 450 includes a top portion 460, which resides over the picture when the cover 450 is mounted on the frame body 200, and also includes side portions 470 (shown here as being opaque, although they may be transparent as well) having dimensions that fit snuggly around the frame body 200. Thus, the frame cover 450 is mounted over the frame body 200 in a fashion similar to placing a lid on a box. In this example, the frame cover 450 can also serve to assist in securing the picture within the frame body 200 by covering the opening 220 when the frame cover 450 is mounted on the frame body 200.

The frame cover 450 can also include a latching mechanism, either to secure the frame cover 450 to the frame body 200, to secure the photo in the frame body 200, or both. For example, the frame cover 450 can include protrusions, extending toward the frame body, on the inside of the side portions 470. Such protrusions can be placed at the four corners of the frame cover 450, on the interior of the longer two sides of the side portions 470, and match up with depressions or holes in the frame body 200 (e.g., a detent mechanism). These protrusions can be used to snap the frame cover 450 onto the frame body 200 and still be releasable using a single hand to squeeze the centers of the longer two sides of the side portions 470, thereby pulling the protrusions out from the holes or depressions with a single squeezing action. Note that the side portions 470 need not connect with each other, or extend completely around the frame cover, as shown in FIG. 4.

The frame covers described above are examples of the types of frame covers contemplated. Other types of quick-release couplings are also possible for securing a frame cover to a frame body as described. In general, the frame cover should be removable using a single hand and without tools, thus allowing an individual to readily change the frame cover, and thereby the appearance of the picture display, as desired. Moreover, the frame cover should be generally transparent to allow the picture to be viewed through the frame cover, but can also include visually opaque decorations, which can range from only slightly opaque to fully opaque (i.e., the frame cover need not be fully transparent at any particular location).

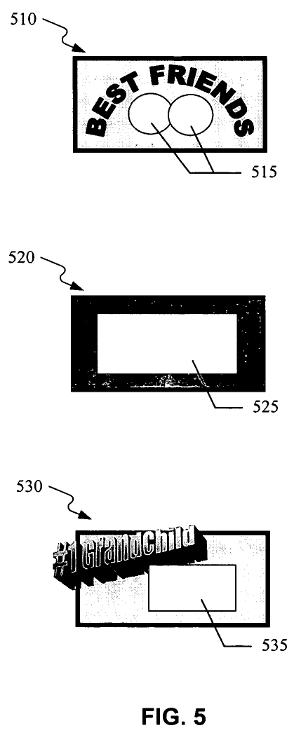

FIG. 5 shows example frame covers 510, 520, 530 including different decorations. As shown, the frame covers can include decoration that provides visual framing of the picture in the frame body through transparent windows 515, 525, 535. Such decoration on the frame cover can include messages (including sayings or trademarks), images (including photographic images or logos), or both. The decoration on the frame cover need not be confined to the lateral dimensions of the frame body, as shown by the frame cover 530. Moreover, the decoration can be partially transparent, fully opaque, or some combination of these.

The invention has been described in terms of particular embodiments. Other embodiments are within the scope of the following claims. For example, the frame can be designed to display multiple pictures simultaneously. The frame can be attached to other interior components of a motorized vehicle, such as a head rest or back pocket of a front seat for viewing from the back seat. Many different types of display options (both images and sayings) are possible for the frame cover, and an individual can be allowed to create their own personalized frame cover, either at the point of sale or by ordering the frame cover for delivery, such as by using software to enable individual frame cover personalization. Moreover, the picture frame device can be used in environments other than a motorized vehicle.

What is claimed is:

1. A picture frame for displaying a picture in a motorized vehicle, the picture frame comprising:
a frame body that receives and holds a picture; and
a frame cover that mounts over the frame body in a quick-release fashion and obscures at least a portion of the picture in the frame body.

2. The picture frame of claim 1, wherein the frame cover comprises a material having a physical property that causes the frame cover to releasably adhere to the frame body.

3. The picture frame of claim 1, wherein the frame body comprises a first magnet and the frame cover comprises a second magnet, wherein magnetic poles of the first and second magnets are arranged to cause the frame body to attract and support the frame cover.

4. The picture frame of claim 1, wherein the frame cover comprises a top portion and side portions, the side portions having dimensions that fit snuggly around the frame body.

5. The picture frame of claim 1, wherein the frame body comprises two transparent plastic panels coupled together at three of four sides.

6. A frame cover for use with a frame body of a picture frame for displaying a picture in a motorized vehicle, the frame cover comprising:
a quick-release coupling to link the frame cover with the frame body; and
a surface including a decoration to obscure at least a portion of the picture in the frame body.

7. The frame cover of claim 6, wherein the quick-release coupling comprises a physical property of the surface that causes the frame cover to releasably adhere to the frame body.

8. The frame cover of claim 6, wherein the quick-release coupling comprises multiple magnets oriented with respect to predefined locations of magnets on the frame body such that the frame body attracts and then supports the frame cover when the frame cover is proximate to the frame body.

9. The frame cover of claim 6, wherein the quick-release coupling comprises side portions of the surface, the side portions having dimensions that fit snuggly around the frame body.

10. The frame cover of claim 6, wherein the decoration is partially transparent and obscures the at least a portion of the picture in the frame body.

11. The frame cover of claim 6, wherein the decoration is opaque to visible light and obscures the at least a portion of the picture in the frame body.

12. The frame cover of claim 6, wherein the decoration comprises a message.

13. The frame cover of claim 6, wherein the decoration comprises an image.

14. The frame cover of claim 6, wherein the decoration provides visual framing of the picture in the frame body by obscuring the at least a portion of the picture in the frame body.

15. An apparatus for displaying a picture on a sun visor in a motorized vehicle, the apparatus comprising a connector configured and arranged to removably couple with the sun visor of the motorized vehicle, a frame configured and arranged to receive and hold the picture for display in the motorized vehicle, and an attachment member configured and arranged to removably couple with at least a portion of the frame to form a connecting interface between the attachment member and the frame, wherein the attachment member includes a decoration that obscures at least a portion of the picture when in the frame, and the attachment member is removable using a single hand and without tools.

16. The apparatus of claim 15, wherein the connector comprises a hook-based fastener.

17. The apparatus of claim 15, wherein the attachment member comprises a material having a physical property that causes the attachment member to releasably adhere to the frame.

18. The apparatus of claim 15, wherein the attachment member comprises a magnet.

19. The apparatus of claim 15, wherein the attachment member comprises a top portion and side portions, the side portions having dimensions that fit snuggly around the at least a portion of the frame to form the connecting interface.

20. The apparatus of claim 15, wherein the decoration is not limited to lateral dimensions of the frame.

21. The apparatus of claim 15, wherein the sun visor comprises a mirror, and the frame is configured to fit on the sun visor without blocking the mirror.
